(19) United States
(12) Patent Application Publication
(10) Pub. No.: US 2015/0176789 A1
(43) Pub. Date: Jun. 25, 2015

(54) COMPOSITE FLOATING LIGHT ASSEMBLY

(71) Applicants: Pedro F. GARCIA, Sandy Springs, GA (US); David D. GARCIA, Duluth, GA (US)

(72) Inventors: Pedro F. GARCIA, Sandy Springs, GA (US); David D. GARCIA, Duluth, GA (US)

(21) Appl. No.: 14/136,778

(22) Filed: Dec. 20, 2013

(51) Int. Cl. F21S 10/04; F21V 21/00; F21V 31/00; F21S 9/02; F21K 99/00

(52) U.S. Cl. CPC F21S 10/04; F21S 9/02; F21K 9/00; F21V 31/00; F21V 21/00; F21W 2121/00

(57) ABSTRACT

A composite floating light assembly includes a wax float and a battery-powered light module, which can be used in containers of liquids, for example, in a vase or centerpiece containing a liquid such as water. Optionally, the composite floating light assembly can be used in a wide manner of containers of liquids including pools, other vases or centerpieces, or in a plurality of other containers of liquids. The composite floating light assembly is configured so that the wax float supports itself and the light module such that the composite light assembly can float in water and operate to give off light.

### BACKGROUND OF THE INVENTION

It is common to use candles to provide a pleasing light. Unfortunately, burning candles present an inherent fire risk and so in many situations candle use is prohibited or discouraged. In some situations, it would be desirable to use a candle on a floating base, floating upon water, to provide a certain pleasing visual effect. But again, using real burning candles is often prohibited or discouraged.

### SUMMARY OF THE INVENTION

Briefly described, in an example form the present invention comprises a composite floating light assembly, such as can be used in pools, in vases, in centerpieces, or in a wide manner of containers of liquids. Advantageously, the composite floating light assembly provides a pleasing appearance, while eliminating the fire risk inherent in having real flames emanating from candles.

Preferably, the composite floating light assembly includes a wax float having a light module-receiving cavity formed therein and a battery-powered light module which is sized and selected to be fitted at least partially in the light module-receiving cavity formed in the wax float. Preferably, the light module includes an LED lamp and is at least water-resistant. Optionally, the light module is water-proof.

Preferably, with the battery-powered light module fitted at least partially in the light module-receiving cavity formed in the wax float, the wax float supports itself and the light module in water such that the composite light assembly can float in water and operate to give off light.

Optionally, the wax float comprises a puck-shaped float. In another optional form, the wax float comprises a donut-shaped float.

In one optional form, the light module-receiving cavity formed in the wax float comprises a first portion in the form of a generally cylindrical bore. Optionally, the light module-receiving cavity further comprises a second portion for receiving the LED lamp and the light module can be placed in the light module-receiving cavity in either of two orientations and the float can be placed in the water in either of two orientations, whereby in one configuration the light module is placed in the cavity with the LED lamp facing in and another in which the LED lamp facing out.

In another example form the composite floating light assembly includes a wax float having a light module-receiving cavity formed therein and a self-contained battery-powered LED light module sized and selected to be fitted at least partially in the light module-receiving cavity formed in the wax float. The light module includes a base or housing and an LED lamp protruding from the base, and the LED light module is at least water-resistant. The LED light module can be placed in the light module-receiving cavity in either of two orientations and the wax float can be placed in the water in either of two orientations, whereby in one configuration the light module is placed in the cavity with the LED lamp facing in and another with the LED lamp facing out. With the battery-powered light module fitted at least partially in the light module-receiving cavity formed in the wax float, the wax float supports itself and the light module such that the composite light assembly can float in water and operate to give off light.

Preferably, the wax float comprises is generally puck-shaped or donut-shaped.

Also preferably, the light module-receiving cavity formed in the wax float comprises a primary cavity for receiving the base or housing of the LED light module and a secondary cavity for receiving the LED lamp protruding from the base or housing of the LED light module. Optionally, the light module-receiving cavity formed in the wax float comprises a generally cylindrical bore.

Optionally, the battery-powered LED light module has an operating mode in which the light emanating from the LED lamp appears to flicker to simulate a candle, or in which the light emanating from the LED lamp cycles between various output colors.

Defined another way, the composite floating light assembly of the present invention includes a generally puck-shaped wax float having a light module-receiving cavity formed therein and a self-contained battery-powered LED light module sized and selected to be fitted at least partially in the light module-receiving cavity formed in the wax float. The LED light module includes a base and an LED lamp protruding from the base, and the LED light module is at least water-resistant. With the battery-powered light module fitted at least partially in the light module-receiving cavity formed in the wax float, the wax float supports itself and the light module such that the composite light assembly can float in water and operate to give off light.

Optionally, the light module-receiving cavity includes a portion for receiving the LED lamp and the light module can be placed in the light module-receiving cavity in either of two orientations and the float can be placed in the water in either of two orientations, whereby in one configuration the light module is placed in the cavity with the LED lamp facing in and another in which the LED lamp is facing out.

### BRIEF DESCRIPTION OF THE DRAWING FIGURES

FIG. 1 is a perspective view of a composite floating light assembly according to an example embodiment of the present invention.

FIG. 2A is a perspective view of a wax float of the composite floating light assembly of FIG. 1.

FIG. 2B is a top view of the wax float of FIG. 2A.

FIG. 2C is a side elevation view of the wax float of FIG. 2A.

FIG. 2D is a bottom view of the wax float of FIG. 2A.

FIG. 3A is a perspective view of a light module portion of the composite floating light assembly of FIG. 1.

FIG. 3B is a perspective view of a light module portion of a composite floating light assembly according to another example embodiment of the present invention.

FIG. 4A is a perspective view of the wax float of FIG. 2A showing the light module removably mounted within the light module-receiving cavity, and wherein the light module is in a first orientation in which the LED lamp is generally facing out from the light module-receiving cavity.

FIG. 4B is a cross-sectional view of the light module removably mounted within the light module-receiving cavity of FIG. 4A.

FIG. 5A is a perspective view of the wax float of FIG. 2A showing the light module removably mounted within the light module-receiving cavity, and wherein the light module is in a second orientation in which the LED lamp is generally facing in towards the light-module-receiving cavity.

FIG. 5B is a cross-sectional view of the light module removably mounted within the light module-receiving cavity of FIG. 5A.

FIG. 6 is a perspective view of a wax float according to another example embodiment of the present invention.

FIG. 7 is a perspective view of a wax float according to another example embodiment of the present invention.

FIG. 8 is a perspective view of a wax float according to another example embodiment of the present invention.

FIG. 9 is a perspective view of a wax float according to another example embodiment of the present invention.

### DESCRIPTION OF EXAMPLE EMBODIMENTS

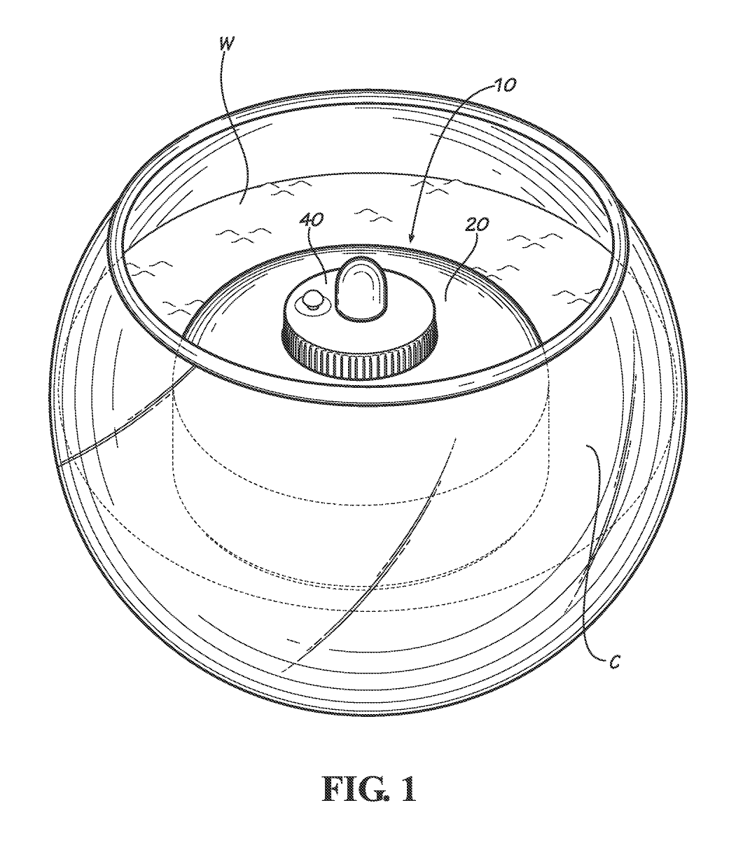

With reference now to the drawing figures, wherein like reference numbers represent corresponding parts throughout the several views, FIG. 1 shows a composite floating light assembly 10 according to an example embodiment of the present invention. In example forms, the composite floating light assembly 10 generally comprises a wax float 20 and a self-contained battery-powered LED light module 40, which can be used in containers of liquids, for example, in a vase or centerpiece C containing a liquid W. Optionally, the composite floating light assembly 10 can be used in a wide manner of containers of liquids including pools, other vases or centerpieces, etc. Preferably, with the light module 40 assembled with the wax float 20, the wax float 20 supports itself and the light module 40 such that the composite light assembly 10 can float in water and operate to give off light. Additionally, the composite floating light assembly is entirely reusable and can be used a plurality of times in one or more different containers of liquids, which is cost effective when comparing to the usable life of a burning candle.

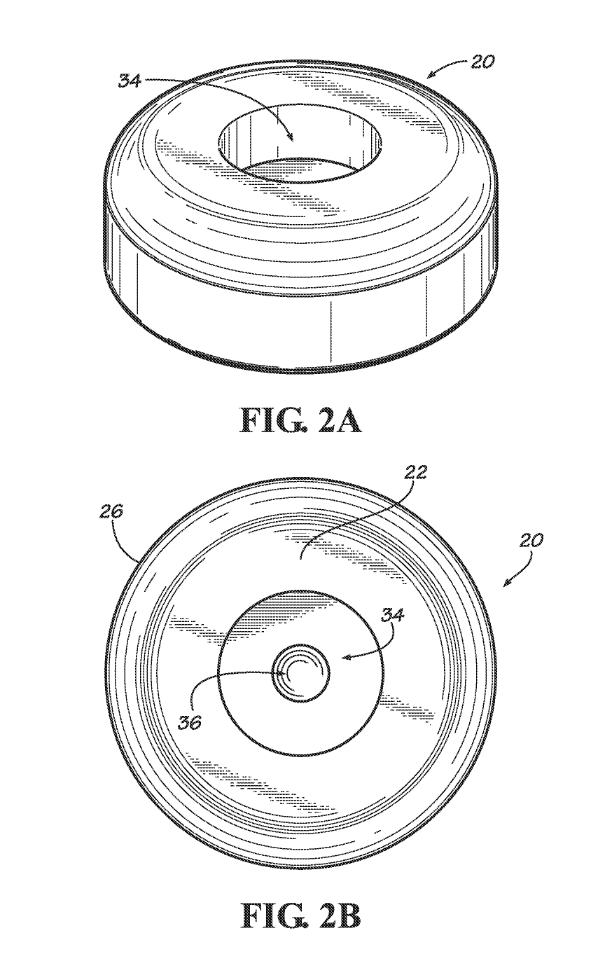

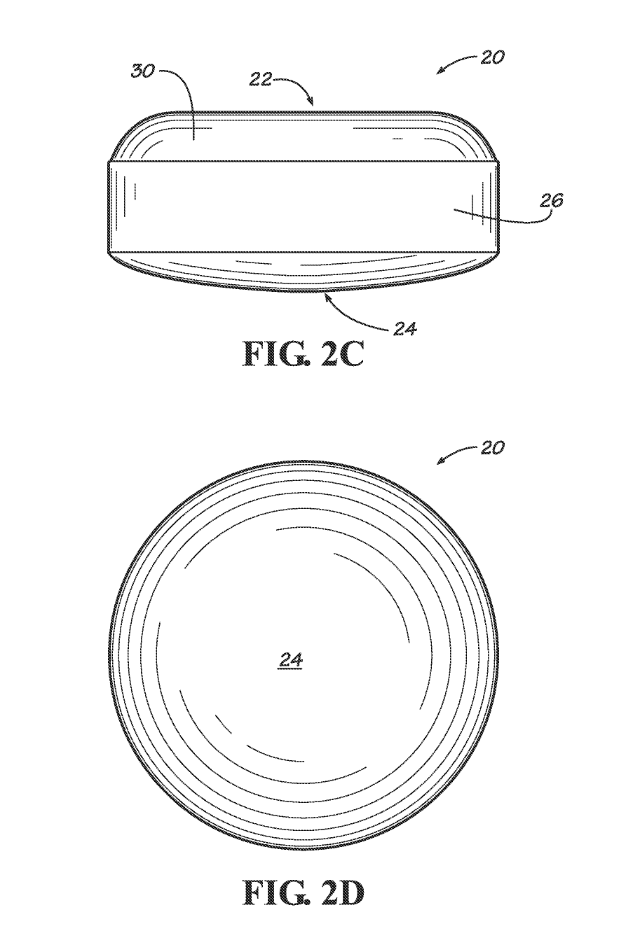

FIGS. 2A-D show the wax float 20 in greater detail. Preferably, the wax float 20 is constructed completely of wax to give the appearance of a wax candle and to provide floatation. More preferably, the wax float 20 has a specific gravity of less than 1.0. In general, the wax float 20 is substantially puck-shaped and comprises a top side 22, a bottom side 24, and a peripheral surface 26 therebetween. In one form, the top side 22 is generally flat and a radiused transition or corner 30 extends therefrom to the peripheral surface 26. The bottom side 24 is generally dome-shaped and defines some amount of curvature or convexity thereon.

Preferably, the top side 22 has a light module-receiving cavity 34 formed therein for receiving the light module 40. In example forms, the light module-receiving cavity 34 is substantially cylindrical in shape and is generally centrally-positioned within the top side 22 of the float 20. In one form, the light module-receiving cavity 34 extends within about one fourth of the thickness (e.g., distance measured from the top side 22 to the bottom side 24) of the float 20, more preferably about one half the thickness of the float 20, and more preferably about three quarters of the thickness of the float 20. Optionally, the cavity includes a first portion in the form of a cylindrical bore and a second portion in the form of a centrally-positioned pocket or recessed portion 36 formed at the bottom of the cavity 34 to provide for receiving a lamp portion of the light module 40 (as will be described below).

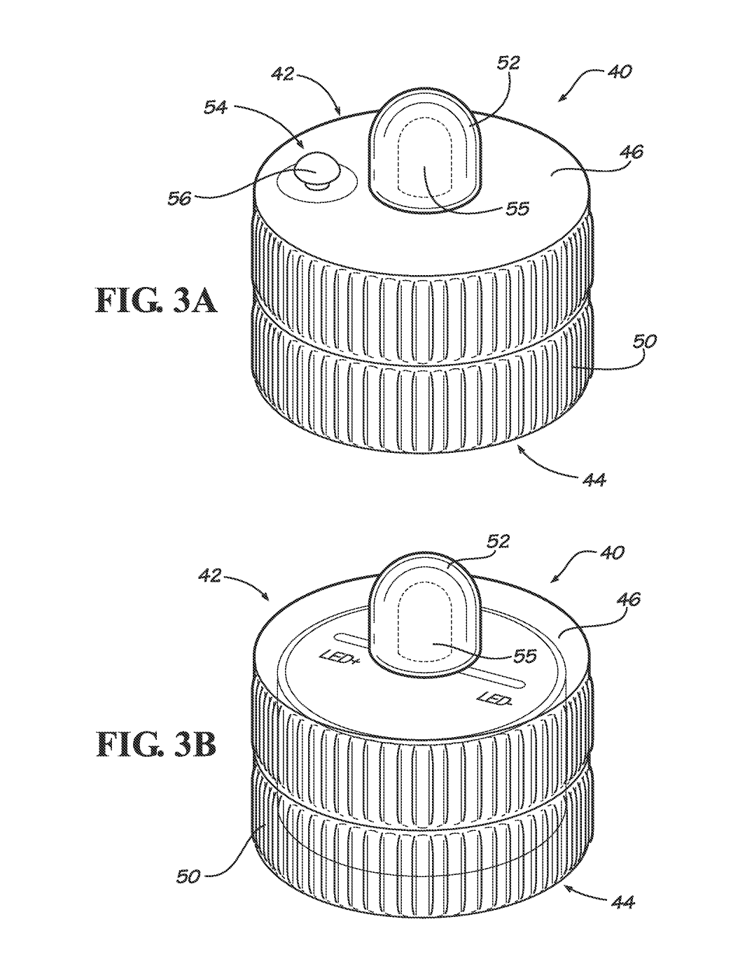

FIGS. 3A-B show embodiments of the light module 40 in greater detail. Generally, the light module 40 is self-contained, battery-operated, electrically-controlled and simulates a candle. In example forms, the light module 40 is generally puck-shaped or cylindrical and is sized and shaped to fit at least partially within the light module-receiving cavity 34. Thus, the light module 40 is configured to be removably fitted within the light module-receiving cavity 34. In one example form, the light module 40 comprises a top end 42, a bottom end 44, a top housing 46, a bottom housing 50, a hollow bulbous projection or LED lamp housing 52, and a control 54. As depicted in FIG. 3A, the LED lamp housing 52 is generally translucent and integrally formed with the top housing 46 and extends therefrom in a direction generally opposite the bottom end 44. Optionally, the LED lamp housing 52 is substantially transparent. In example forms, the top housing 46 and the bottom housing 50 each comprise a threaded portion (unshown) that provide for interengagement therebetween to fasten the top housing 46 to the bottom housing 50, for example, so as to keep any water-sensitive electronics, batteries, bulb(s), etc. that are housed therein free from contact with any liquid, which could potentially cause the light module 40 to become inoperable. A rubber or polymer seal of gasket can be provided, as desired, to enhance sealing against moisture intrusion. Thus, in some forms, the light module 40 is at least water-resistant, and in other forms, the light module is water-proof.

Preferably, an LED lamp 55 is housed within the LED lamp housing 52 such that light given off by the LED lamp 55 emanates therefrom and through the housing 52. Optionally, the control 54 is provided for controlling the operation of the light module 40 between multiple operating modes. For example, the light module 40 can be configured such that the control 54 is operative to control the light emanating from the LED lamp 55 cycles between an off mode, a constant on mode, a flicker mode, a blinking mode (e.g., cycles between on and off), or a variable color mode. Preferably, the flicker mode is configured to provide an appearance substantially similar to a fire-burning candle. In some example forms, the LED lamp 55 comprises an amber-like color to simulate the color of a candle. In other forms, the LED lamp 55 can provide for outputting one color and/or for outputting multiple colors.

As depicted in FIG. 3A, the control 54 is in the form of a push button 56, which is generally provided on the top housing 46 and offset from the LED lamp housing 52. Preferably, the push button 56 can be pressed with a user's finger to switch between the different operating modes. Optionally, the control 54 can be incorporated within a portion of the housing of the light module 40. For example, as depicted in FIG. 3B, the control 54 is incorporated in the bottom housing 50 such that fastening or coupling the bottom housing 50 to the top housing 46 with cause the LED lamp 55 to operate and give off light. Preferably, partially uncoupling or unfastening the bottom housing 50 from the top housing 46 will cause the LED lamp 55 to stop operating. In some example forms, the top and bottom housing 46, 50 are coupled together in a screw-like, twisting manner such that when the top and bottom housing 46, 50 are substantially coupled together, the control 54 is caused to operate.

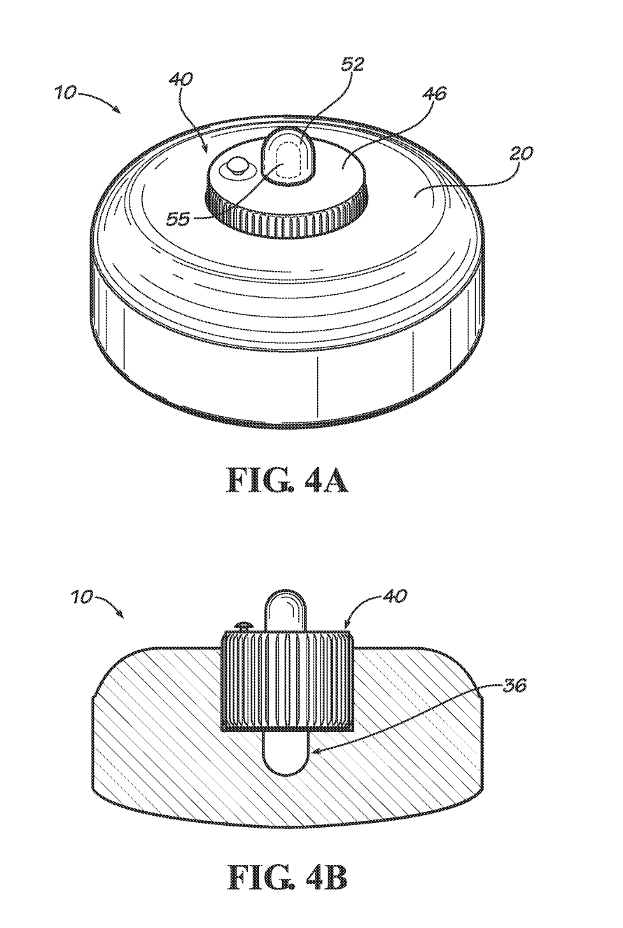

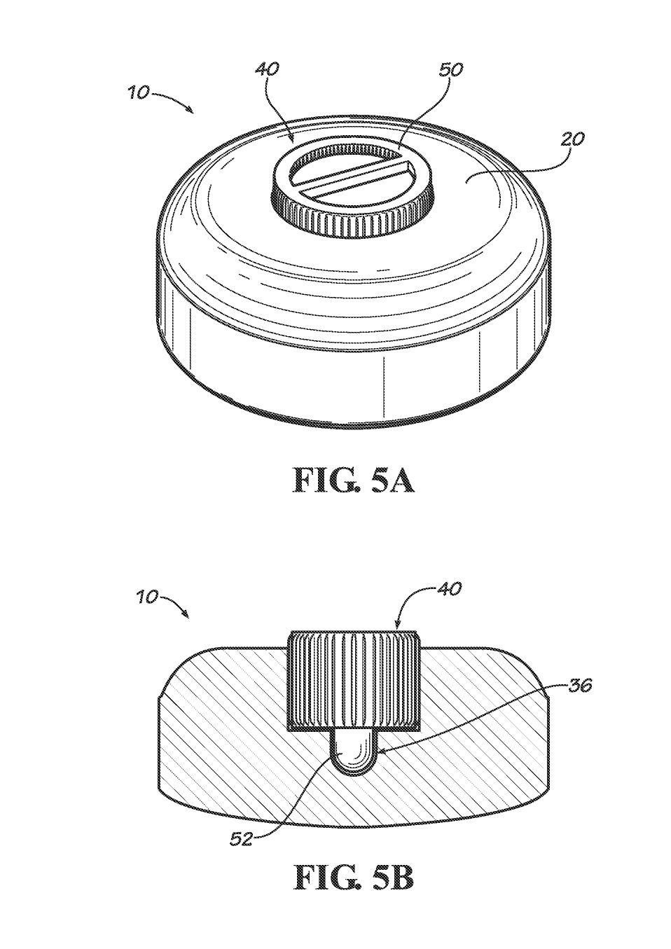

FIGS. 4A-5B show the light module 40 assembled with the wax float 20. Preferably, the light module 40 can be fitted within the light module-receiving cavity 34 in either of two orientations. For example, as depicted in FIGS. 4A-B, the light module 40 is fitted within the light module-receiving cavity so that the LED housing 52 (and LED lamp 55) is facing out in a direction generally opposite the bottom end 24 of the wax float 20. Thus, when the light module 40 is orientated in this manner, the wax float 20 can be orientated in either of two orientations when placed on the liquid W, for example wherein the light module 40 remains out of contact with the liquid W such that the bottom end 24 of the float 20 is submerged in the liquid W (see FIG. 1), or wherein at least a portion of the light module 40 and the top end 22 are submerged in the liquid W.

Optionally, the light module 40 can be fitted within the light module-receiving cavity 34 in an orientation generally opposite the above-described orientation. As depicted in FIGS. 5A-B, the light module 40 is fitted within the cavity wherein the LED housing 52 is received within the recessed portion 36 of the light module-receiving cavity 34 such that the bottom housing 50 is generally visible and adjacent the top end 22 of the float 20. As similarly described above, with the LED housing 52 received within the recessed portion 36, the wax float 20 can preferably be orientated in either of two orientations when placed on the liquid W, for example, in an orientation wherein the bottom end 24 is substantially submerged in the liquid W or in an orientation wherein the top end 24 and a portion of the light module 40 are at least partially submerged in the liquid W.

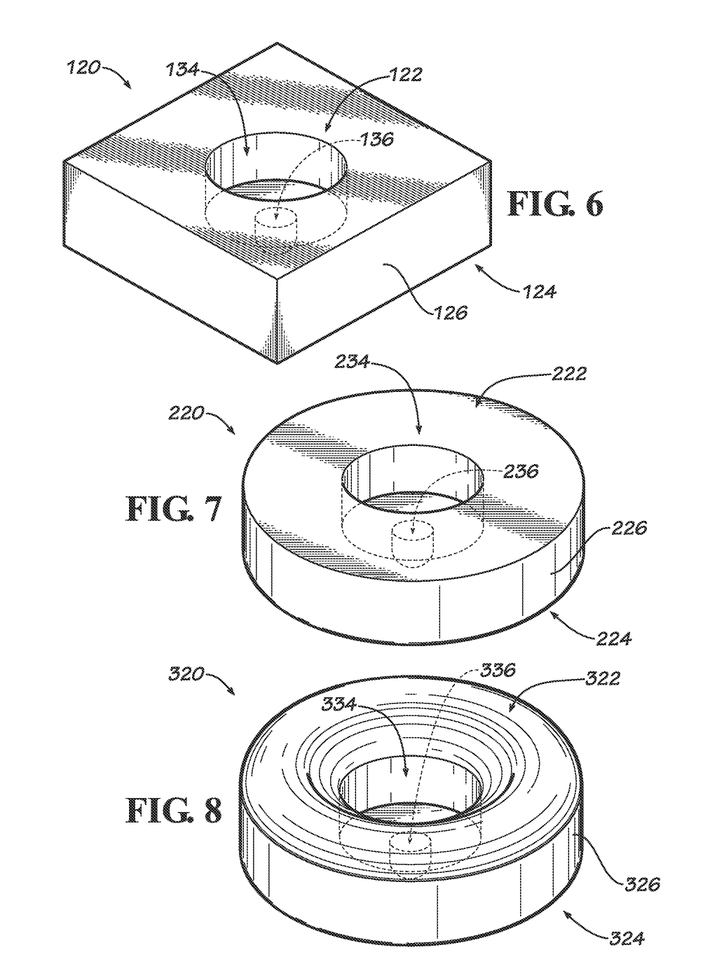

FIGS. 6-8 show a wax float according to additional example embodiments of the present invention. As depicted in FIG. 6, the wax float 120 is substantially block-shaped and comprises a substantially flat top end 122, a substantially flat bottom end 124, a periphery 26 extending therebetween, a generally centrally-positioned light module-receiving cavity 134, and a recessed portion 136 defined within the bottom of the cavity 134. As depicted in FIG. 7, the wax float 220 is substantially puck-shaped and comprises a substantially flat top end 222, a substantially flat bottom end 224, a periphery 226 extending therebetween, a generally centrally-positioned light module-receiving cavity 234, and a recessed portion 236 defined within the bottom of the cavity 234. As depicted in FIG. 8, the wax float 320 is substantially puck-shaped and comprises a donut-shaped top end 322, a substantially flat bottom end 324, a periphery 326 extending therebetween, a generally centrally-positioned light module-receiving cavity 334, and a recessed portion 336 defined within the bottom of the cavity 234. Optionally, in other example forms, the wax float can be substantially completely donut-shaped, block-shaped, or otherwise shaped as desired.

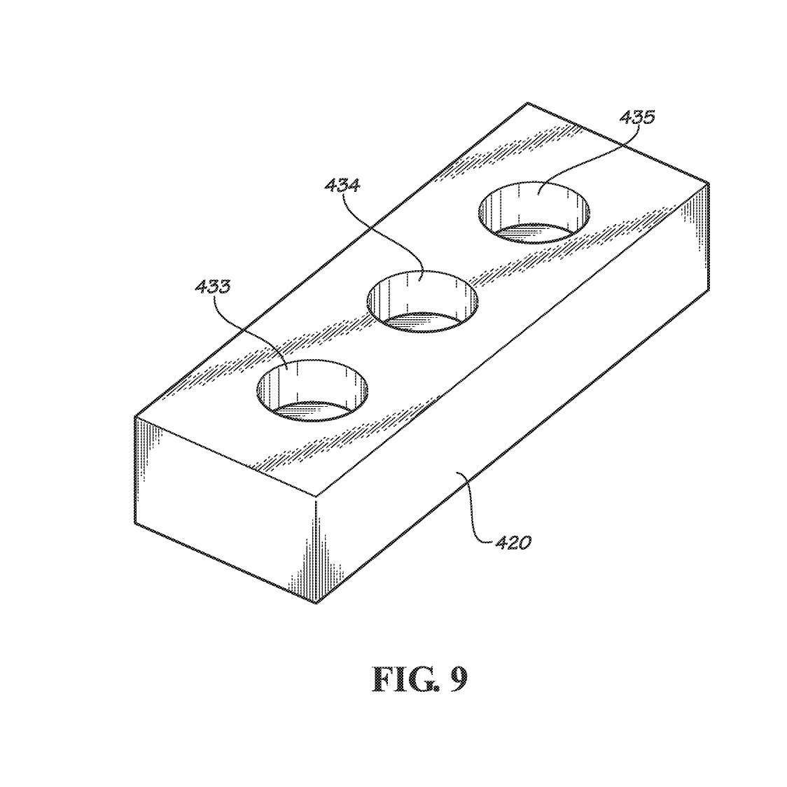

FIG. 9 shows another form of the wax float, here an elongate block-shaped float 420 having multiple light module-receiving cavities 433, 434, 435 formed therein. In this illustration, the light modules are omitted for clarity/simplicity.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

1. A composite floating light assembly, comprising:
a wax float having a light module-receiving cavity formed therein;
a self-contained battery-powered LED light module sized and selected to be fitted at least partially in the light module-receiving cavity formed in the wax float, the light module including a housing and an LED lamp protruding from the housing, wherein the LED light module is at least water-resistant;
wherein the LED light module can be placed in the light module-receiving cavity in either of two orientations and the wax float can be placed in the water in either of two orientations, whereby in one configuration the light module is placed in the cavity with the LED lamp facing in and another with the LED lamp facing out; and
wherein with the battery-powered light module fitted at least partially in the light module-receiving cavity formed in the wax float, the wax float supports itself and the light module such that the composite light assembly can float in water and operate to give off light.

2. The composite floating light assembly of claim 1 wherein the wax float comprises a generally puck-shaped float.

3. The composite floating light assembly of claim 1 wherein the wax float comprises a generally donut-shaped float.

4. The composite floating light assembly of claim 1 wherein the light module-receiving cavity formed in the wax float comprises a primary cavity for receiving the housing of the LED light module and a secondary cavity for receiving the LED lamp protruding from the housing of the LED light module.

5. The composite floating light assembly of claim 1 wherein the light module-receiving cavity formed in the wax float comprises a generally cylindrical bore.

6. The composite floating light assembly of claim 1 wherein wax float is provided with more than one light module-receiving cavity formed therein.

7. The composite floating light assembly of claim 1 wherein the wax float is provided with three light module-receiving cavities formed therein.

8. The composite floating light assembly of claim 2 wherein the puck-shaped wax float has somewhat sharp corners so that it has the appearance of being a section of a cylinder.

9. The composite floating light assembly of claim 2 wherein the puck-shaped wax float has large-radius rounded corners.

10. A composite floating light assembly, comprising:
a generally puck-shaped wax float having a light module-receiving cavity formed therein;
a self-contained battery-powered LED light module sized and selected to be fitted at least partially in the light module-receiving cavity formed in the wax float, the light module including a housing and an LED lamp protruding from the housing, wherein the LED light module is at least water-resistant;
wherein with the battery-powered light module fitted at least partially in the light module-receiving cavity formed in the wax float, the wax float supports itself and the light module such that the composite light assembly can float in water and operate to give off light.

11. The composite floating light assembly of claim 10 wherein the puck-shaped wax float comprises a generally squat, cylindrical puck-shaped float.

12. The composite floating light assembly of claim 10 wherein the light module-receiving cavity formed in the wax float comprises a generally cylindrical bore.

13. The composite floating light assembly of claim 12 wherein the light module-receiving cavity further comprises a portion for receiving the LED lamp and wherein the light module can be placed in the light module-receiving cavity in either of two orientations and the float can be placed in the water in either of two orientations, whereby in one configuration the light module is placed in the cavity with the LED lamp facing in and another with the LED lamp facing out.

14. The composite floating light assembly of claim 10 wherein the wax float is provided with more than one light module-receiving cavity formed therein.
